(19) United States
(12) Patent Application Publication
(10) Pub. No.: US 2025/0277622 A1
(43) Pub. Date: Sep. 4, 2025

(54) METHOD AND SYSTEM FOR CURING COATINGS FROM THE INSIDE OUT

(71) Applicant: PTI IP LLC, Cleveland, OH (US)

(72) Inventors: Don W. COCHRAN, Gates Mills, OH (US); Mark F. FLEMING, Strongsville, OH (US); Steven D. CECH, Richfield, OH (US)

(73) Assignee: PTI IP LLC, Cleveland, OH (US)

(21) Appl. No.: 18/593,024

(22) Filed: Mar. 1, 2024

(51) Int. Cl. F26B 3/30; F26B 25/22

(52) U.S. Cl. CPC F26B 3/30; F26B 25/22

(57) ABSTRACT

A method, or system implementing such a method, are provided to uniformly cure a coating located on a substrate or heat the substrate to affect curing of the coating. The exemplary process heats the coating from the substrate outward to affect drying or curing with unique advantages over conventional curing methods. The implementation, in at least one form, uses arrays of narrowband semiconductor irradiation devices (NREDs) configured to emit energy in a narrow wavelength band suitable for generating heat at the substrate and at an absorption rate at the substrate for the selected bandwidth.

### BACKGROUND

The industrial coatings curing industry is evolving as companies try to reduce their carbon footprint and reduce the use of Volatile Organic Compounds (VOCs) in paints, stains, and other coating compositions. Currently, industries curing liquid or powder coatings primarily use natural gas fired, forced convection, for heating and curing.

Forced convection heating systems have been the most common cure systems used in industry. Some estimates peg them at greater than 80% share of the cure systems available due to their simple designs, and relative to other broadband heating sources, effective heat transfer to the target. They are sized by determining how much heat is required to bring a part's mass up to temperature and then maintaining the required dwell time to cure the coating. However, changes in formulation and desires for faster cure times are posing problems. With the industry push for more water-based coatings, conditions have changed. Water based coatings usually require more time than solvent based coatings to flash-off the liquid making it difficult to optimize cure times as well as finished product quality.

Forced convection systems have a plethora of inefficiencies. They require long heat up time, high energy consumption, large floor area and some additional setups for air circulation inside the oven. These systems need high circulation and turnover of air within their chambers to ensure that volatile compounds do not build up and ignite or cause an explosion. Additionally, the oven must run negative pressure relative to the production environment to prevent escaping volatiles into the work area and to direct the volatiles within the chamber up through the exhaust flue. These two requirements draw factory air into the oven, exhausting considerable volumes of air up the flue. The resultant energy and heat loss can be substantial. A good rule of thumb used in industrial operations is to exhaust 10,000 cu ft of air for every gallon of solvent driven off in the oven to ensure the oven atmosphere remains below the lower explosive limit of the solvent. In large cure operations this can amount to a sizeable amount of air and therefore a sizeable amount of wasted heat.

Also, high airflow across the target is needed to effect efficient heat transfer as the heat transfer coefficient is a direct relationship to velocity of air across the target. The high airflow rate can cause issues with dust or defects being impinged into the coating, or in the case of powder coating, powder blow off.

Sometimes the products of combustion are not compatible with the coating. In these cases, indirect-fired heater units are an option. These use air-to-air heat exchangers and may require one third more energy to operate.

Other disadvantages of convection ovens are that they are difficult to zone. Also, they require careful air balancing for acceptable results.

Every oven must be exhausted. Exhaust creates a negative environment so that air seals operate properly and remove VOCs and other cure products from the oven. Additionally, the exhaust purges the oven prior to start-up. The requirement for purge is to change the enclosure atmosphere four times in approximately 20 min prior to ignition.

Further exacerbation of the problem of energy loss through the need for high ventilation occurs when the products of the cure and combustion combine and come in contact with a direct flame. NOx gases are produced. These gases contribute to respiratory issues, form ground-level ozone, and contribute to acid rain. In these situations, larger amounts of air are introduced into the heating area. This lowers the temperature of the flame heated air to a point where NOx gases are not produced. In the process, even more energy is lost up the flue.

The next most common type of cure oven are broadband infrared ovens. These ovens are designed for a peak wave output in the mid-infrared wavelength range, but some can have a maximum temperature of approximately 4000° F. which equates to a wavelength of roughly 1.17 microns. Most medium wave elements have a maximum temperature of approximately 1800-2000° F. which equates to 2.3-2.12 microns. The current useable infrared range is typically considered to go from 1.17-5.4 microns (4000° F.-500° F.). As a rule of thumb, in broadband infrared ovens, approximately 25% of the energy comes from the wavefronts smaller than the peak and 75% from those longer than the peak.

With respect to use of broadband infrared ovens, as absorption goes up, transmissivity goes down. As such, choosing high absorptive wavelengths for broadband IR radiators has many drawbacks. For example, with high absorption, as the majority of the energy is absorbed on the surface, premature curing is caused on the surface. In addition, this concentration of localized heat can cause burning and discoloration at the surface.

### SUMMARY

In accordance with one aspect of the present exemplary embodiments, a method for drying or curing a target coating layer deposited on a target substrate comprises moving a coated target substrate item into an irradiation area, the irradiation area being defined by an open-atmosphere enclosure or oven chamber including at least one sensor, for irradiation by at least one array of narrowband infrared radiation emitting devices (NREDs) which produce at least 10.4 Watts per square inch of narrowband infrared energy at a target plane, wherein the NREDs are configured to have a Full Width at Half Maximum (FWHM) wavelength spectrum width of less than 80 nanometers (nm) and an output peak wavelength in a range of 720 nm to 1180 nm range, wherein a wavelength peak of selected narrowband energy has an absorption rate in the target substrate which is at least 75% that of the target coating layer and wherein, if the target coating layer is in liquid form, an absorption rate at the selected peak output wavelength of the target substrate is at least one of two times that of water and two times that of a primary liquid in the target coating layer, detecting, in the irradiation area using the at least one sensor, at least one physical property of at least one of the target coating layer, the target substrate, or a particular molecule in the atmosphere of the enclosure or oven chamber, collecting information from the at least one sensor on the at least one detected physical property, translating the information on the at least one detected physical property into a measurement or sequence of measurements, and, executing a heating process utilizing the at least one array of NREDs and utilizing instructions to bring the coating layer and the target substrate to a desired state in accordance with the measurement, the sequence of measurements, or the collected information from the at least one sensor, wherein the method further comprises continuously controlling amperes of electrical current being supplied by a Direct Current (DC) power supply, using a control system operatively connected to at least one of the DC power supply operatively connected to the at least one array of NREDs or the DC power supply used in conjunction with at least one electrical component which can limit current to the at least one array of NREDs.

In accordance with another aspect of the present exemplary embodiments, the irradiation area is supplied at least 10.4 Watts of narrowband photonic energy to each of at least 12 square inches of target plane.

In accordance with another aspect of the present exemplary embodiments, the at least one sensor is a sensor operatively connected to the control system.

In accordance with another aspect of the present exemplary embodiments, the at least one sensor is placed in at least one of before, in, and after the at least one irradiation zone, if the target substrate is being irradiated by moving it through the irradiation area.

In accordance with another aspect of the present exemplary embodiments, the instructions comprise stored code.

In accordance with another aspect of the present exemplary embodiments, the executing of the heating process includes utilizing information from at least one of machine learning algorithms and artificial intelligence.

In accordance with another aspect of the present exemplary embodiments, the target substrate is moved through the irradiation area, the target substrate is coated within at least one of an area before entering the irradiation area, an area within the irradiation area, and an area of after exiting the irradiation area.

In accordance with another aspect of the present exemplary embodiments, the at least one sensor is a temperature sensor.

In accordance with another aspect of the present exemplary embodiments, the at least one sensor is an infrared sensor, calibrated to monitor temperature.

In accordance with another aspect of the present exemplary embodiments, the at least one sensor is an infrared camera.

In accordance with another aspect of the present exemplary embodiments, the at least one sensor is a digital, visible light, camera.

In accordance with another aspect of the present exemplary embodiments, the at least one sensor is a Raman spectral sensor.

In accordance with another aspect of the present exemplary embodiments, a method for drying or curing a target coating layer deposited on a target substrate in which the target substrate has temperature sensitivity of at least becoming softer and deforming at higher temperatures, comprises moving a coated target substrate item into an irradiation area, the irradiation area being defined by an open-atmosphere enclosure or oven chamber including at least one sensor, for irradiation by at least one array of narrowband infrared radiation emitting devices (NREDs) which produce at least 10.4 Watts per square inch of narrowband infrared energy at a target plane, wherein the NREDs are configured to have a Full Width at Half Maximum (FWHM) wavelength spectrum width of less than 80 nanometers (nm) and an output peak wavelength in a range of 720 nm to 1180 nm range, wherein a wavelength peak of selected narrowband energy has an absorption rate in the target substrate which is at least 75% that of the target coating layer and wherein, if the target coating layer is in liquid form, an absorption rate at the selected peak output wavelength of the target substrate is at least one of two times that of water and two times that of a primary liquid in the target coating layer, detecting, in the irradiation area using the at least one sensor, at least one physical property of at least one of the target coating layer, the target substrate, or a particular molecule in the atmosphere of the enclosure or oven chamber, collecting information from the at least one sensor on the at least one detected physical property, translating the information on the at least one detected physical property into a measurement or sequence of measurements, and, executing a heating process utilizing the at least one array of NREDs and instructions to maintain a majority of the target substrate below a glass transition temperature or an autoignition temperature of the target substrate for a duration of the heating process in accordance with the at least one sensor positioned in the system through varying at least one of irradiation intensity, activation time of the NRED's, and speed of conveyance through the irradiation zone, wherein the method further comprises continuously controlling amperes of electrical current being supplied by a Direct Current (DC) power supply, using a control system operatively connected to at least one of the DC power supply operatively connected to the at least one array of NREDs or the DC power supply used in conjunction with at least one electrical component which can limit current to the at least one array of NREDs.

In accordance with another aspect of the present exemplary embodiments, the irradiation area is supplied at least 10.4 Watts of narrowband photonic energy to each of at least 12 square inches of target plane.

In accordance with another aspect of the present exemplary embodiments, the at least one sensor position is operatively connected to the control system.

In accordance with another aspect of the present exemplary embodiments, the at least one sensor is placed in at least one of before, in, and after the irradiation area.

In accordance with another aspect of the present exemplary embodiments, the instructions comprise stored software code.

In accordance with another aspect of the present exemplary embodiments, the software code is informed of instructions for the heating process based on historical sensor input data and at least one of machine learning algorithms and artificial intelligence.

In accordance with another aspect of the present exemplary embodiments, the target substrate is moved through the irradiation area and is coated within at least one of an area before entering the irradiation area, an area within the irradiation area, and an area after exiting the irradiation area.

In accordance with another aspect of the present exemplary embodiments, the at least one sensor is a temperature sensor.

In accordance with another aspect of the present exemplary embodiments, the at least one sensor is an infrared sensor, calibrated to monitor temperature.

In accordance with another aspect of the present exemplary embodiments, the at least one sensor is an infrared camera.

In accordance with another aspect of the present exemplary embodiments, the at least one sensor is a digital, visible light, camera.

In accordance with another aspect of the present exemplary embodiments, the at least one sensor is a spectral image sensor.

In accordance with another aspect of the present exemplary embodiments, the NREDs have a FWHM wavelength spectrum width of less than 80 nm and an output peak wavelength in the 720 nm to 1180 nm range are further paired with any type of broadband heat source.

In accordance with another aspect of the present exemplary embodiments, the broadband heat source comprises one of quartz lamps, halogen lamps, heating from chemical reactions such as oxidizing combustibles to create flames, or resistive heating elements.

In accordance with another aspect of the present exemplary embodiments, a system for drying or curing a target coating layer deposited on a target substrate comprises at least one array of narrowband infrared radiation emitting devices (NREDs) configured to emit energy in a narrow wavelength band suitable for implementing a drying or curing process for the target coating layer on the target substrate, at least one sensor positioned to detect or measure physical properties of at least one of the target coated layer, the target substrate, or a particular molecule in an atmosphere, and, at least one processor and at least one memory having stored thereon code or instructions that, when executed by the processor, cause the system to move a coated target substrate item into an irradiation area, the irradiation area being defined by an open-atmosphere enclosure or oven chamber including at least one sensor, for irradiation by at least one array of narrowband infrared radiation emitting devices (NREDs) which produce at least 10.4 Watts per square inch of narrowband infrared energy at a target plane, wherein the NREDs are configured to have a Full Width at Half Maximum (FWHM) wavelength spectrum width of less than 80 nanometers (nm) and an output peak wavelength in a range of 720 nm to 1180 nm range, wherein a wavelength peak of selected narrowband energy has an absorption rate in the target substrate which is at least 75% that of the target coating layer and wherein, if the target coating layer is in liquid form, an absorption rate at the selected peak output wavelength of the target substrate is at least one of two times that of water and two times that of a primary liquid in the target coated layer, detect, in the irradiation area using the at least one sensor, at least one physical property of at least one of the target coating layer, the target substrate, or the particular molecule in the atmosphere of the enclosure or oven chamber, collect information from the at least one sensor on the at least one detected physical property, translate the information on the at least one detected physical property into a measurement or a sequence of measurements, and, execute a heating process utilizing the at least one array of NREDs and instructions to bring the coating layer and the target substrate to a desired state in accordance with the measurement, the sequence of measurements, or the collected information from the at least one sensor, wherein the system is further caused to continuously control amperes of electrical current being supplied by a Direct Current (DC) power supply, using a control system operatively connected to at least one of the DC power supply operatively connected to the at least one array of NREDS or the DC power supply used in conjunction with at least one electrical component which can limit current to the at least one array of NREDs.

In accordance with another aspect of the present exemplary embodiments, the irradiation area is supplied at least 10.4 Watts of narrowband photonic energy to each of at least 12 square inches of target plane.

In accordance with another aspect of the present exemplary embodiments, the irradiation area is supplied at least 10.4 Watts of narrowband photonic energy to each of at least 40 square inches of target plane.

In accordance with another aspect of the present exemplary embodiments, a system for drying or curing a target coating layer deposited on a target substrate in which the target substrate has temperature sensitivity of at least becoming softer and deforming at higher temperatures, comprising at least one array of narrowband infrared radiation emitting devices (NREDs) configured to emit energy in a narrow wavelength band suitable for implementing a drying or curing process for the target coating layer on the target substrate, at least one sensor positioned to detect or measure physical properties of at least one of the target coating layer, the target substrate, or a particular molecule in an atmosphere, and, at least one processor and at least one memory having stored thereon code or instructions that, when executed by the processor, cause the system to move a coated target substrate item into an irradiation area, the irradiation area being defined by an open-atmosphere enclosure or oven chamber including at least one sensor, for irradiation by at least one array of narrowband infrared radiation emitting devices (NREDs) which produce at least 10.4 Watts per square inch of narrowband infrared energy at a target plane, wherein the NREDs are configured to have a Full Width at Half Maximum (FWHM) wavelength spectrum width of less than 80 nanometers (nm) and an output peak wavelength in a range of 720 nm to 1180 nm range, wherein a wavelength peak of selected narrowband energy has an absorption rate in the target substrate which is at least 75% that of the target coating layer and wherein, if the target coating layer is in liquid form, an absorption rate at the selected peak output wavelength of the target substrate is at least one of two times that of water and two times that of a primary liquid in the target coating layer, detect, in the irradiation area using the at least one sensor, at least one physical property of at least one of the target coating layer, the target substrate, or a particular molecule in the atmosphere of the enclosure or oven chamber, collect information from the at least one sensor on the at least one detected physical property, translate the information on the at least one detected physical property into a measurement or a sequence of measurements, and, execute a heating process utilizing the at least one array of NREDs and instructions to maintain a majority of the target substrate below a glass transition temperature or an autoignition temperature of the target substrate for a duration of the heating process in accordance with the at least one sensor positioned in the system through varying at least one of irradiation intensity, activation time of the NRED's, and speed of conveyance through the irradiation zone, wherein the system is further caused to continuously control amperes of electrical current being supplied by a Direct Current (DC) power supply, using a control system operatively connected to at least one of the DC power supply operatively connected to the at least one array of NREDS or the DC power supply used in conjunction with at least one electrical component which can limit current to the at least one array of NREDs.

In accordance with another aspect of the present exemplary embodiments, the irradiation area is supplied at least 10.4 Watts of narrowband photonic energy to each of at least 12 square inches of target plane.

In accordance with another aspect of the present exemplary embodiments, the the irradiation area is supplied at least 10.4 Watts of narrowband photonic energy to each of at least 40 square inches of target plane.

In accordance with another aspect of the present exemplary embodiments, a method for drying or curing a target coating layer deposited on a target substrate comprises moving a coated target substrate item into an irradiation area, the irradiation area being defined by an open-atmosphere enclosure or oven chamber, for irradiation by at least one array of narrowband infrared radiation emitting devices (NREDs) which produce at least 10.4 Watts per square inch of narrowband infrared energy at a target plane, wherein the NREDs are configured to have a Full Width at Half Maximum (FWHM) wavelength spectrum width of less than 80 nanometers (nm) and an output peak wavelength in a range of 720 nm to 1180 nm range, executing a heating process utilizing the at least one array of NREDs to bring the coating layer and the target substrate to a desired state wherein the irradiation area is supplied at least 10.4 Watts of narrowband photonic energy to each of at least 12 square inches of target plane, and wherein the method further comprises continuously controlling amperes of electrical current being supplied by a Direct Current (DC) power supply, using a control system operatively connected to at least one of the DC power supply operatively connected to the at least one array of NREDs or the DC power supply used in conjunction with at least one electrical component which can limit current to the at least one array of NREDs.

In accordance with another aspect of the present exemplary embodiments, a system for drying or curing a target coating layer deposited on a target substrate comprises at least one array of narrowband infrared radiation emitting devices (NREDs) configured to emit energy in a narrow wavelength band suitable for implementing a drying or curing process for the target coating layer on the target substrate, and, at least one processor and at least one memory having stored thereon code or instructions that, when executed by the processor, cause the system to move a coated target substrate item into an irradiation area, the irradiation area being defined by an open-atmosphere enclosure or oven chamber, for irradiation by at least one array of narrowband infrared radiation emitting devices (NREDs) which produce at least 10.4 Watts per square inch of narrowband infrared energy at a target plane, wherein the NREDs are configured to have a Full Width at Half Maximum (FWHM) wavelength spectrum width of less than 80 nanometers (nm) and an output peak wavelength in a range of 720 nm to 1180 nm range, and execute a heating process utilizing the at least one array of NREDs and instructions to bring the coating layer and the target substrate to a desired state wherein the irradiation area is supplied at least 10.4 Watts of narrowband photonic energy to each of at least 12 square inches of target plane, and wherein the system is further caused to continuously control amperes of electrical current being supplied by a Direct Current (DC) power supply, using a control system operatively connected to at least one of the DC power supply operatively connected to the at least one array of NREDS or the DC power supply used in conjunction with at least one electrical component which can limit current to the at least one array of NREDs.

### DRAWINGS

FIG. 1 illustrates broadband heat transfer to a coated substrate and the resultant film development as cure is initiated; and

FIG. 2 illustrates narrowband heat transfer at a wavelength specifically chosen to affect heat in the substrate with less heating effects within the coating;

FIG. 3 illustrates an open atmosphere irradiation chamber implementing an example system according to the presently described embodiments;

FIG. 4 is a flowchart relating to an example method according to the presently described embodiments; and,

FIG. 5 is a flowchart relating to an example method according to the presently described embodiments.

### DETAILED DESCRIPTION

In an attempt to minimize hold times during a curing operation and to address the inefficiencies in forced air convection ovens as noted above, some curing operations have added broadband infrared radiant ovens to pretreat the coated part or as a secondary operation to finish the cure. However, water is a broadband energy absorber with absorption peaks at approximately 3- and 6-microns when exposed to electromagnetic radiation waves within the mid-infrared wavelength range. 3- and 6-microns are two primary harmonics for the hydrogen and oxygen covalent bonds in water. Consequently, water molecules more readily absorb energy at these wavelengths causing near instantaneous heating at the surface of the water. And although some of the broadband infrared energy is in the shorter wavelengths in which weak overtone harmonics and non-harmonizing wavelengths can penetrate through the coating without being absorbed so as to be absorbed by the substrate creating heat, water is such a good broadband energy absorber that the majority of the energy is absorbed by the water in the coating generating heat at or very near the surface of the coating with delayed heating effect at the substrate caused by conduction from the surface heat.

Those skilled in the art of designing broadband infrared heating elements currently design their products to emit broadband wavelengths with peak radiance output in the approximate 3-micron wavelength even though this peak produces deleterious effects. This frequency is a first level harmonic with the water molecules' covalent bonds readily converting the photon of energy from the electromagnetic wavelength into heat within the water molecule. The long tail of broadband energy further imparts substantial energy at water's next major absorption level of 6-microns. As such, near zero penetration of heat beyond the surface into the water-based coating occurs from radiation at these wavelengths as almost all of the photons of energy are absorbed within the first molecules the wave encounters and heat is primarily generated within the surface molecules. With the primary energy absorbed at the surface molecules, heating of the coating starts at the surface, much like with forced air convection heating systems. Heat is then transmitted from the surface to the interior of the coating using conduction. As humidity within the chamber, or thickness of the coatings vary, localized heating can occur and lead to the deleterious effects of off coloring, decreased coating strength and/or loss of lubricity.

Some skilled in the art have designed broadband infrared heating ovens with a peak output in the 1.17-micron range. And although this moves the peak of the energy off of the primary absorption frequency for water, the long tail of energy has substantial transmittance in the 1.4-micron range, a strong absorption frequency for water, as well as energy in the 3- and 6-micron range. Better penetration of heat could be expected, but issues will still arise with heat being generated at more of the surface of the coating causing the issues outlined above.

U.S. Pat. No. 5,261,165 to Setsuo Tate teaches the importance of using near infrared wavelengths to heat the substrate and coating at separate rates to achieve more uniform heating at the substrate. However, he teaches using broadband energy sources. As such the curing method must be achieved in a minimum two stage process. One energy level and broadband source is used to heat the substrate first followed by another energy density and broadband source to complete the cure. He rightly recognizes that differing wavelengths will penetrate the coating better than others. However, he does not recognize that these broadband sources have approximately 75% of their wavelengths in wavelengths longer than the peak wavelength chosen—meaning they have substantial energy in the mid-infrared range where high resonance, or high absorption, exist in the base chemicals used in the coatings identified as well as high resonance and high absorption in water, the more common base chemical used today. He addresses this lack of understanding by identifying that the initial heating will need to be done at a much lower energy intensity.

Incorrectly taught in U.S. Pat. No. 5,261,165 is the importance of the molecular absorption in the mid-infrared wavelength range. In this case, wavelengths range from approximately 3-microns to 10-microns. Not recognized is that at these wavelengths the covalent bonds in the molecules identified have a primary harmonic resonance with the identified wavelengths, meaning they are highly absorptive of the energy of these wavelengths. At this high of an absorptance, the only way to minimize overheating is to dramatically decrease the light intensity. Not taught is that by targeting the weaker overtone harmonics in the near-infrared range absorptive rates are dramatically reduced allowing for deeper penetration and more even heating in the coating and at the substrate.

The issue U.S. Pat. No. 5,261,165 is trying to address is further exacerbated when water becomes the primary medium in a coating. Water has a strong resonance harmonic at the peak wavelength identified as 1.4-microns and a primary resonance at 3-microns. Even utilizing a two-stage process of first heating with a 1.4-micron broadband peak followed by a 3.4-micron broadband peak will generate excessive heat in water-based coatings with the associated negative effects noted above.

In addition to the deleterious effects of heat on the coating as noted above, the rate of how a coating cures is also important. If a film forms too quickly on the outside of the coating, gases get trapped causing bubbles, pinholes, divots, etc. in the final cure. Historically, VOCs have been used to break up, or disperse the resins and pigments in the coatings. In addition, VOCs hold the components of the coating in suspension for the application. They are used to improve flow and ensure consistent coating of finished products. Importantly, they are used to control off-gases at a rate that ensures good film coalescence from latex and other plasticizers needed to impart desirable coatings characteristics. However, VOCs typically are derived from petroleum-based products and have not only a high carbon component, but also contain hazardous solvents. As such, industry has been trying to replace VOCs with more water in their formulations. This has caused issues with traditional ovens as described above as water is a broadband energy absorber in the wavelength ranges of typical ovens making it difficult to balance the proper level of heat soaking and off gassing. Specifically, if water on the surface of a coating heats too quickly, the resultant vapor off gases too quickly causing films to form and the coating to set before all the water or VOCs can escape without causing damage to the final finish.

U.S. Pat. No. 6,069,200A to Ming et al. teaches the manufacture and use of curable coating compositions that are substantially aqueous based as a way to replace VOCs. What is not taught, but known to those skilled in the art, is that VOCs have a much higher vapor pressure than that of water—meaning that they evaporate much faster. In order to compensate for the slower evaporation, higher water content coatings must be cured at a higher temperature or for longer. Both methods of compensation can have a deleterious effect on the final product. One such effect is that holding metals at a higher temperature or for longer can cause the metal to anneal and soften requiring more metal to be used to achieve the same strength. Another effect is higher temperatures can damage the polymers of the coating affecting desired characteristics of the cured product. Some examples would be undesirable yellowing, or color transitions in the final product as well as decreased coating strength and/or lubricity.

Given these limitations of the two most prominent methods of curing industrial coatings, using a chamber to heat air or atmosphere which in turn heats the outer layer coating of the target, and the limitations of broadband infrared cure ovens which transmit their energy overwhelmingly into the surface molecules of water creating films on the surface first as the coating cures and thereby trapping gasses which have deleterious effects when they escape, it is desirable to more evenly heat a coating and to cure it from the substrate outwards, or without forming an outer film over the coating before it can be fully dried. Not doing so results in subpar surface finishes and heat damage to the desired final state polymer structure of the coating.

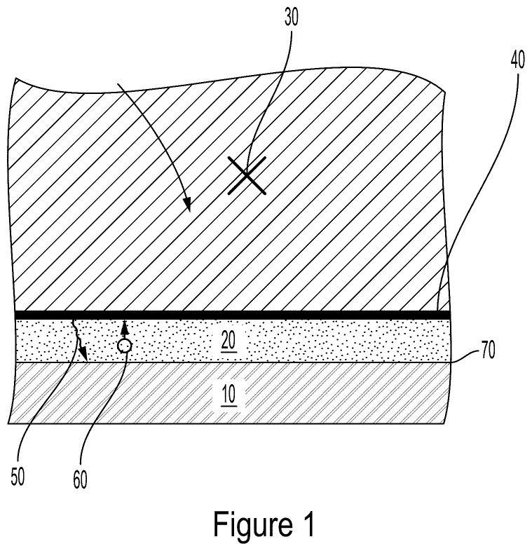

FIG. 1 shows an example of the substrate (10) with a coating (20). In this example, a metal is represented. However, in addition to metals, the substrates can be plastic, wood, or other materials. As shown, broadband energy from a forced air convection oven or broadband irradiating device (30) generates heat on the coating. Most of the energy is absorbed at the surface generating heat in the liquid, causing the liquid to evaporate. As the liquid is expelled, a film (40) begins to form and the coating begins to cure. Being broadband energy and due to convection, some energy penetrates (50). If the energy absorbed on the surface is at a rate high enough that liquid is still between the coating and the substrate after a solid film has been formed, the liquid will vaporize (60) producing undesirable results such as pinholes, crazing, divots, etc. in the final finish. Another problem with historic broadband heating systems is that when the substrate is plastic, deformation of the substrate due to heat may occur.

The presently described embodiments relate to a novel way of generating heat in industrial cure operations to execute a cure of a coating more efficiently and effectively than could be achieved in heretofore conventional techniques. In at least one form, this includes utilizing at least one narrowband radiance or radiation emitting device (referred to as an NRED) that generates at least 10.4 Watts per square inch (1.6 Watts per square centimeter) in at least one peak wavelength between 720 nanometers and 1180 nanometers and having a Full Width at Half Maximum (FWHM) of spectrum wavelength of 80 nanometers (nm) or less, such that the vibrational frequency is not significantly absorbed by the primary or any other significant chemical composition of the coating such as water or VOCs relative to the substrate being coated. It should be appreciated that an NRED may take a variety of forms. For example, a light emitting diode (LED), laser diode (such as surface emitting laser diodes) or other device that emits energy or irradiation in a sufficiently narrow wavelength band may be used to meet the noted parameters and/or be used to implement the presently described embodiments. Again, a narrowband source to be implemented in accord with the presently described embodiments may take many suitable forms, but one example of an NRD to implement the presently described embodiments (with appropriate modification, if necessary) is described in co-pending, commonly owned U.S. application Ser. No. ______ filed ______ (Atty Docket No. PTIP 200138US01) (listing Don W. Cochran, Mark F. Fleming, and Steven D. Cech as inventors) and entitled “NRED Oven Device”, which application is incorporated herein by reference in its entirety.

As an example to illustrate the presently described embodiments, water-based epoxies used to coat aluminum sheets are primarily composed of water. By illuminating the coated aluminum with a concentration of at least 10.4 Watts per square inch (1.6 Watts per square centimeter) or greater at a wavelength of 940 nanometers, little of this energy is absorbed by the water relative to the aluminum substrate or other fillers in the coating. The aluminum substrate and coating will absorb this energy at a rate greater than 3 times that of the water. Unlike conventional heating methods, where the surface and the surface liquid are heated first and then the substrate, in this case, the substrate heats relative or greater to the water in the coating maintaining the key components of the coating in solution until the appropriate temperatures are achieved at the substrate to start the appropriate linkages and cure. The advantage is that as VOCs and the water base of the coating heat and transition from their liquid state to a vapor state and exit the coating they do not have to migrate through a well-established surface film which may occur using traditional heating methods causing defects in the coating.

An advantage to using digital, instant-on instant-off, narrowband generated, directional heat is that the exact amount of heat injected into a target can be calculated; as such, the exact temperature can be maintained at the target. By monitoring temperature of the target and using instant-on instant-off, digital, narrowband radiant waves in the near infrared wavelength, the substrate can be held at an exact temperature until the coating has cured.

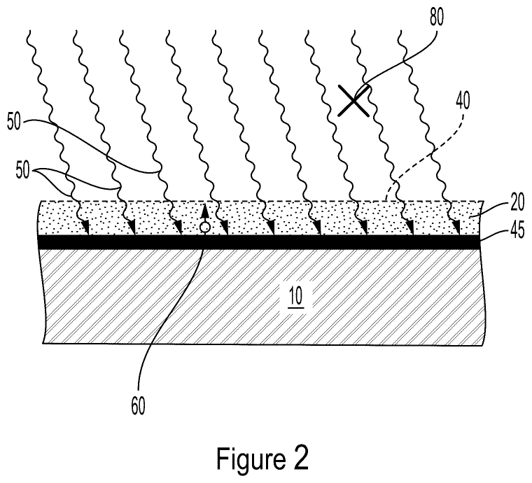

In this regard, as shown in FIG. 2, a substrate (10) is coated with a liquid based or solid, powder based, coating (20) and heated with narrowband semiconductor produced energy in a narrow wavelength band (80). The energy, in at least one form, is suitable for generating heat at the substrate while having minimal, or not having substantially more, heat absorbed in the coating. The resultant film formation (45) from the heat occurs at the warmer substrate. The resultant gases (60) generated from the evaporating liquid from the heat application can evaporate and be expelled without being trapped by, and damaging, a surface film (40). It is to be appreciated that the surface film (40) of FIG. 2 is substantially thinner than the surface film of FIG. 1 and does not prevent the escape of water and other gasses from the curing process. As a result, the disadvantages of the prior broadband techniques noted above are avoided.

In another form, the substrate is coated with a solid, powder based, coating and heated with narrowband semiconductor produced energy in a narrow wavelength band. The powder-based coating being comprised of a single compound or a plethora of compounds designed to affect various end results on the coated surface. The energy, in at least one form, is suitable for generating heat in at least one component of the solid, powder based, coating. The energy, in at least one form, is suitable for generating heat at the substrate while having minimal, or not having substantially more, heat absorbed in at least one component in the powder-based coating.

The presently described embodiments could be implemented in a variety of different environments to dry and/or cure coatings on substrates. In at least one form of the presently described embodiments, a method, or system implementing such a method, to at least uniformly heat a coating located on a substrate, or heat the substrate, is implemented. The exemplary process heats the coating from the substrate outward to affect drying or curing. The implementation, in at least one form, uses arrays of narrowband semiconductor irradiation devices (NREDs) configured to emit energy in a narrow wavelength band suitable for generating heat at the substrate and at an absorption rate at the substrate for the selected bandwidth, wherein the absorption rate of the substrate is at least 75% that of the coating and if the coating is in a liquid form, at least two times that of pure water or two times that of the primary liquid in the coating.

In at least one form of the presently described embodiments, at least one sensor is positioned in the system to detect or measure physical properties of the coated target, the system, or environment before, during, or after, or any, or all three of the curing stages, and at least one processor and at least one memory having stored thereon code or instructions that, when executed by the processor, cause the system to collect information from the sensors on the detected or measured physical properties, and effect change in time of the target in the system, intensity of the irradiation from the arrays, or both. Depending on the implementation, the at least one sensor is, for example, a temperature sensor, an infrared sensor calibrated to monitor temperature, an infrared camera, a digital visible light camera, or a Raman spectral sensor.

Further, in at least one form, when processing, e.g., when curing according to the presently described embodiments, it will be appreciated that the presently described embodiments gather information during the process and use such information for feedback and/or control. In this regard, it should be appreciated that, in at least one form, the presently described embodiments include detecting, by at least one sensor positioned in an irradiation area, e.g., an enclosure (e.g., open-atmosphere enclosure) or oven chamber, at least one physical property of at least one of the target coating layer, the target substrate or a particular molecule in the atmosphere of the enclosure or chamber. Information on the detected property or properties is collected. This information is, in one example form, translated to the at least one measurement or a sequence of measurements. The physical properties, measurement(s), and collected information, and translations to measurement(s), will vary according to implementations, as described in the example implementations herein. Heating instructions are executed to achieve certain objectives, e.g., to bring the target coating layer or substrate to a desired state or maintain a certain condition or conditions, in accordance with at least one of: the at least one physical property detected by the at least one sensor positioned in the system, the at least one measurement, the sequence of measurements or collected information. That is, the heating instructions are executed, in accordance with the at least one sensor or at least one of: the detecting, collecting or the translating.

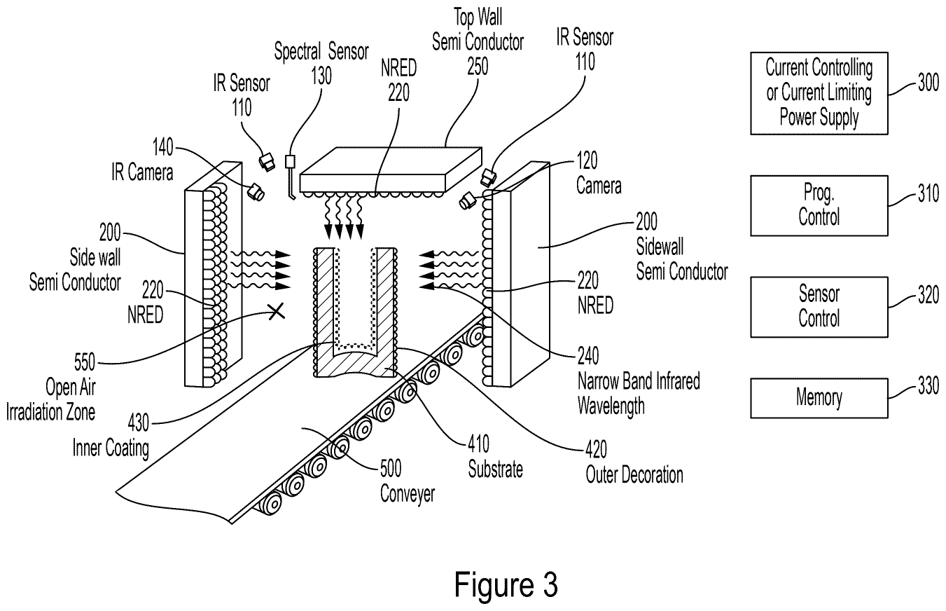

In one example implementation, with reference to FIG. 3, the coated substrate 410 with a coating 420 is positioned into an at least one irradiation area or zone 550. In the irradiation area or zone 550, the coated substrate is exposed to irradiation of at least one narrowband of infrared radiation 240. The narrowband irradiation 240 has a Full Width at Half Maximum (FWHM) spectrum wavelength of less than 80 nanometers (nm) and an output peak wavelength in the 720 nm to 1180 nm range. In this environment, the coated substrate 410 is exposed to a desired irradiation pattern generated from at least one narrowband, semiconductor-based radiation emitting device (NRED) 220. The irradiation from the at least one NRED, e.g., the at least one array of NREDs, may be continuous or pulsed, depending on the implementation and/or environment. Within the irradiation zone or zones, irradiation is achieved utilizing a current controlling power supply or current limiting device 300 to affect irradiation intensity. In at least one form, the irradiation is at an intensity of at least 10.4 Watts per square inch (1.6 Watts per square centimeter). Further, the irradiation area is supplied at least 10.4 Watts of narrowband photonic energy to each of at least 12 square inches of target plane. This metric of 12 square inches may vary depending on the implementation. For example, 40 square inches or any other suitable area or size of the target plane may be supplied, as described, with at least 10.4 Watts of narrowband photonic energy. The 12 square inches (or 40 square inches, or another suitable area or size) may be contiguous, or may be in a discontinuous pattern, such as a checkerboard pattern.

Also shown in FIG. 3 are a program controller 310, sensor controller 320 and a memory 330. The example system includes at least one of an IR camera 140, an infrared (IR) sensor 110, a camera 120 and a spectral sensor 130.

In this regard, the system is provided with appropriate control and processing capability. In one form, the system includes a processor or controller 310 to control, among other functions and hardware, the narrowband arrays 200 that are strategically implemented in the system, e.g., in the irradiation area 550, to radiate the target substrate with narrowband energy according to various recipes. The system is also provided with a sensor control system or controller 320 to control sensors in the system, including the IR sensors 110 (such as an IR sensor calibrated to monitor temperature) and cameras such as camera 120 (such as a digital visible light camera) and IR camera 140 (and spectral sensor 130, such as a Raman sensor). Any type or combination of sensors may be used according to the environment and/or implementation to detect, for example, a physical property of the target coating layer, the target substrate or a particular molecule in the atmosphere of the enclosure or other chamber. The physical properties may include a variety of physical properties such as, for example, temperature, a physical attribute, or other properties detectable by the sensor or sensor system used, including the sensors and/or systems described herein.

It should be appreciated that the at least one sensor may be configured and supported in a variety of ways. For example, the sensor(s) may be operatively connected to the control system having sensor control capability, for example, in the circumstance where a separate sensor control system is not defined. It should be further appreciated that the at least one sensor is placed in at least one of before, in, and after the at least one irradiation zone, if the target substrate is being irradiated by moving it through the irradiation area.

In at least one form, a variation of the presently described embodiments includes pairing the NREDs having a FWHM wavelength spectrum width of less than 80 nm and an output peak wavelength in the 720 nm to 1180 nm range with any type of broadband heat source. For example, the broadband heat source may comprise one of quartz lamps, halogen lamps, heating from chemical reactions such as oxidizing combustibles to create flames, or resistive heating elements.

Of course, a memory unit 330, or several memory units, are included in the system. In this regard, the presently described embodiments, in at least one example, include suitable software program(s) (e.g., instructions and/or code which are stored on the at least one memory 160) which, when executed by at least one processor, cause the processor and/or associated elements of the system to implement the method(s) according to the presently described embodiments.

Also, it will be appreciated that the structures and procedures shown above are only a representative example of embodiments that can be used to facilitate embodiments described above. In this regard, the various embodiments described in the examples above may be implemented using any suitable circuitry, hardware, and/or software modules that interact to provide particular results. One of skill in the computing arts can readily implement such described functionality, either at a modular level or as a whole, using knowledge generally known in the art. For example, the methods described herein may be used to create computer-readable instructions/code for execution by a processor. Such instructions may be stored on a non-transitory computer-readable medium and transferred to, for example, the processor for execution as is known in the art.

In this regard, it should be appreciated that the processors and controllers and the sensor controllers are merely examples—they may take a variety of forms. For example, the above-described methods and/or techniques can be implemented on a system such as an oven, heating tunnel, or similar device using well-known computer processors, memory units, storage devices, computer software, and other components. As shown in the example representations of such a system, the units include at least one processor, which controls the overall operation of the units by executing computer program instructions which define such operation and a sensor controller. The computer program instructions may be stored in at least one storage device or memory (e.g., a magnetic disk or any other suitable non-transitory computer readable medium or memory device) and loaded into another memory (not shown) (e.g., a magnetic disk or any other suitable non-transitory computer readable medium or memory device), or another segment of memory, when execution of the computer program instructions is desired. Thus, the steps of the methods described herein may be defined by the computer program instructions stored in the memory and controlled by the processors (and/or the controllers) executing the computer program instructions.

According to various embodiments, FIG. 3 is an example representation of possible components of a system including a processor for illustrative purposes. Of course, the system may include other components. Also, the tunnel or oven is illustrated as primarily a single device or system. However, they may be implemented as more than one device or system and, in some forms, may be a modular or distributed system with components or functions suitably distributed in, for example, a network or in various locations.

Of course, other configuration variations may also be implemented. In one example, irradiation occurs from the top-wall semiconductor 250 and from at least one of the sidewall semiconductors 200. In another example, irradiation occurs from just the top-wall semiconductor 250. In another example, irradiation occurs from an at least one of the sidewall semiconductor(s) 200

Further, a variety of methods according to the presently described embodiments may be implemented in, for example, an arrangement as shown in FIG. 3, or other suitable arrangements. It should be appreciated that ovens utilizing semiconductor produced, narrow-band energy with a FWHM spectrum wavelength of 80 nm or less operate, at the molecular level, by matching the photons of a particular wavelength to the resonance frequency of specific covalent bonds. Contrary to common belief, covalent bonds in molecules are not rigid, like sticks or rods, but are more like stiff springs that can be stretched and bent. As such, molecules experience a wide variety of vibrational motions whose characteristics are relative to their component atoms. Consequently, virtually all organic molecules will absorb infrared radiation that corresponds in energy to the appropriately matched vibrations.

Because of the quantum nature of light, it comes in packets of energy. Covalent bonds absorb energy from light in a quantum fashion, not linear fashion, as well. The formula is as follows:

E=hc/λ
where E is the energy, h is a number called Planck's constant, c is the speed of light and λ is the length of the wavelength.

The presently described embodiments use light waves and the quantum phenomena of energy transfer from electromagnetic radiation to a molecule to bring it to an excited energy state as it absorbs the light photon in turn generating heat. Electromagnetic radiation, also known as light, is generated at specific frequencies in the near IR that correspond to the absorption harmonics that affect change in the energy state of a targeted molecule. By utilizing an overtone harmonic in the near-IR, versus the primary absorption frequency in the mid-IR, weaker absorption occurs at the covalent bond level of the molecule and, therefore, deeper penetration into an amalgamation of molecules occurs. The result is a usable rate of energy transfer and deeper penetration of heat into the target.

Unlike nature and broadband heating methods, in a semiconductor produced, narrowband energy oven, specific wavelengths can be generated to effect heating on specific molecules while avoiding others. In nature, because water is a broadband absorber in all but some of the near-infrared infrared wavelengths, all broadband heating methods tend to overly cause heating of coatings containing water.

The mechanism of heat generation using narrowband infrared light is as follows: All matter above absolute zero vibrates. The covalent bonds within molecules resonate with certain vibration frequencies. Electromagnetic energy, also known as light, contains quantum packets of energy vibrating relative to the light's frequency. Absorption of light within matter, regardless of the wavelength, is based on the quantum vibrational states of the material being illuminated. In organic material the primary vibrational state typically corresponds with mid-infrared wavelengths. The ability of photons from near-infrared light to be absorbed by an organic molecule is much weaker in intensity as compared with wavelengths in or closer to mid-infrared light frequencies. This is due to the near-infrared wavelength being an overtone, or harmonic, to the primary mid-infrared frequency that matches the particular quantum state or vibrational level of the electrons in the covalent bonds in the organic molecule. As such, light generated in the near-infrared range provides a unique opportunity to match specific wavelengths of energy to specific covalent bonds to effect absorption at a rate that allows for deep penetration into an amalgamation of molecules while avoiding unwanted heating effects on other molecules such as water.

As an example, in the approximate 2.7 to 3.3 micron range the O—H covalent bond in molecules such as water, H2O, and the N—H covalent bonds achieve maximum stretching vibration from the quantum energy delivered at this frequency. As such water exposed to electromagnetic radiation of 3 microns absorbs and quickly converts all light energy at this wavelength into heat with almost zero penetration beyond the surface.

Using narrowband infrared light at a known rate of energy injection is a dramatically improved method of curing coatings. Using a source with a known energy output directed at the target allows for the precise heat needed to effect change in the coating without overheating or underheating the coating and/or substrate. Furthermore, using infrared light energy for heat transfer versus conventional forced air convection ovens bypasses the boundary layers around the target that inhibits heat transfer. In conventional convection ovens the rate of heat transfer is directly proportional to the temperature differential between the target and the atmosphere in the oven. In addition, heat transfer is directly proportional to the airflow across the target. Higher airflow decreases the boundary layer thus accelerating heat transfer. When using light sources to generate heat, heat transfer is related to the intensity of the light and the absorption characteristics of the target. Light passes directly through the air and transitions to heat in direct proportion to the target's absorption characteristics.

As a further alternative, when using semiconductor generated instant-on, instant-off, narrowband radiance emitting devices, thermal sensors can be added to monitor changes in temperature of the surface as part of a feedback loop to automate the heating process. The instant-on, instant-off nature of the semiconductor generated, narrowband radiance emitting devices provide a superior control mechanism over conventional ovens. In addition, the intensity of these devices can also be quickly adjusted to affect the amount of heat available at the target at any given moment.

Conventional forced air convection ovens in which the mass of air must first be heated before that heat can be transferred to the target cannot be adjusted to have fast temperature profile changes at the target. Time is needed for the mass of air to equilibrate and transfer heat at a consistent rate. Much like the forced air convection ovens, conventional, broadband, infrared ovens also need time for their infrared generating elements to come up to temperature, or reduce temperature, so they emit the proper broadband wavelengths. In addition, broadband infrared ovens cannot effectively be used to control heat by instantly changing light intensity. Being a broadband source of energy, changes in intensity could have a deleterious effect on the amount of heat absorbed at the surface or within the components of the coating, dramatically affecting the coating's finish, color, lubricity, etc.

Also, it will be appreciated that the thermal or temperature sensor is only a representative example of embodiments described that could be used to control the semiconductor generated instant-on, instant-off, narrowband radiance emitting devices to affect a desired outcome. A plethora of other characteristics such as color, lubricity, spectral refraction, as well as others could be used to monitor the desired outcome in real-time to adjust curing intensities.

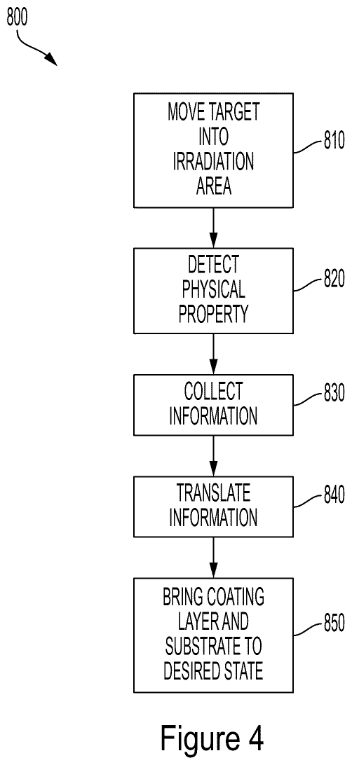

One example method according to the presently described embodiment is illustrated in FIG. 4. As shown, a method 800 for drying or curing a target coating layer deposited on a target substrate is initiated by moving (at 810) a coated target substrate item into an irradiation area, the irradiation area being defined by an open-atmosphere enclosure or oven chamber. The configuration of the system may vary; however, in some forms, the target substrate is coated within at least one of an area before entering the irradiation area, an area within the irradiation area, and an area of after exiting the irradiation area.

The irradiation area also includes at least one sensor. The irradiation area is further provided with at least one array of narrowband infrared radiation emitting devices (NREDs) for irradiation which produce at least 10.4 Watts per square inch of narrowband infrared energy at a target plane, wherein the NREDs are configured to have a Full Width at Half Maximum (FWHM) wavelength spectrum width of less than 80 nanometers (nm) and an output peak wavelength in a range of 720 nm to 1180 nm range. Further, a wavelength peak of selected narrowband energy has an absorption rate in the target substrate which is at least 75% that of the target coating layer and, if the target coating layer is in liquid form, it has an absorption rate at the selected peak output wavelength of the target substrate is at least one of two times that of water and two times that of a primary liquid in the target coating layer. During this process, the at least one sensor detects (at 820), in the irradiation area, at least one physical property of at least one of the target coating layer, the target substrate, or a particular molecule in the atmosphere of the enclosure or oven chamber. The system then collects (at 830) information from the at least one sensor on the at least one detected physical property and translates (at 840) the information on the at least one detected physical property into a measurement or sequence of measurements. At this point, the system executes a heating process utilizing the at least one array of NREDs and instructions such as stored instructions or code to bring the coating layer and the target substrate to a desired state (at 850) in accordance with the measurement, the sequence of measurements, or the collected information from the at least one sensor. The instructions may be based on a variety of resources; however, in at least one form, the executing of the heating process includes utilizing information from at least one of machine learning algorithms and artificial intelligence.

It should be appreciated that the method 800 also includes continuously controlling the amperes of electrical current being supplied by a Direct Current (DC) power supply. To do so, a control system is used to operatively connect to at least one of the DC power supply operatively connected to the at least one array of NREDS or the DC power supply used in conjunction with at least one electrical component which can limit current to the at least one array of NREDs.

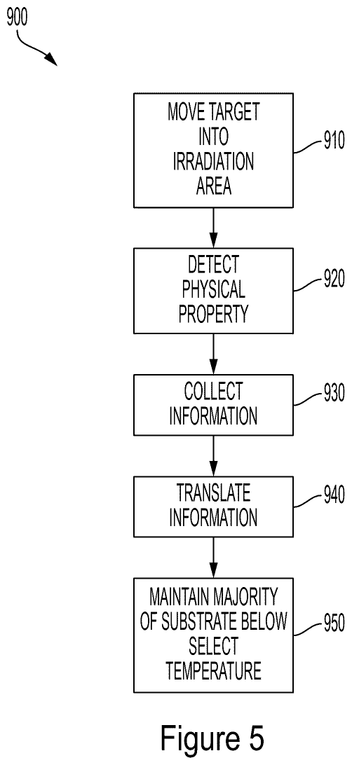

Another example method according to the presently described embodiments is illustrated in FIG. 5. As shown, a method 900 for drying or curing a target coating layer deposited on a target substrate in which the target substrate has temperature sensitivity of at least becoming softer and deforming at higher temperatures is initiated by moving (at 910) a coated target substrate item into an irradiation area, the irradiation area being defined by an open-atmosphere enclosure or oven chamber including at least one sensor. As noted previously, the configuration of the system may vary; however, in some forms, the target substrate is coated within at least one of an area before entering the irradiation area, an area within the irradiation area, and an area of after exiting the irradiation area.

For irradiation, at least one array of narrowband infrared radiation emitting devices (NREDs) is provided which produce at least 10.4 Watts per square inch of narrowband infrared energy at a target plane, wherein the NREDs are configured to have a Full Width at Half Maximum (FWHM) wavelength spectrum width of less than 80 nanometers (nm) and an output peak wavelength in a range of 720 nm to 1180 nm range. Also, a wavelength peak of selected narrowband energy has an absorption rate in the target substrate which is at least 75% that of the target coating layer and, if the target coating layer is in liquid form, has an absorption rate at the selected peak output wavelength of the target substrate of at least one of two times that of water and two times that of a primary liquid in the target coating layer. The system implementing the method detects (at 920), in the irradiation area using the at least one sensor, at least one physical property of at least one of the target coating layer, the target substrate, or a particular molecule in the atmosphere of the enclosure or oven chamber. Information is collected (at 930) from the at least one sensor on the at least one detected physical property and translated (at 940) into a measurement or sequence of measurements. A heating process is then executed utilizing the at least one array of NREDs and instructions such as stored instructions or code (such as software code) to maintain (at 950) a majority of the target substrate below a selected temperature such as a glass transition temperature or an autoignition temperature of the target substrate for a duration of the heating process in accordance with the at least one sensor positioned in the system through varying at least one of irradiation intensity, activation time of the NRED's, and speed of conveyance through the irradiation zone. The instructions may be based on a variety of resources; however, in at least one form, the executing of the heating process includes utilizing information from at least one of machine learning algorithms and artificial intelligence. It will also be appreciated that suitable detection and/or monitoring will, in at least one form, be implemented to maintain a majority of the target substrate below a selected temperature such as a glass transition temperature or an autoignition temperature of the target substrate for a duration of the heating process, as noted.

It should be appreciated that as the method 900 is executed, it continuously controls amperes of electrical current being supplied by a Direct Current (DC) power supply. To do so, a control system is used that is operatively connected to at least one of the DC power supply operatively connected to the at least one array of NREDS or the DC power supply used in conjunction with at least one electrical component which can limit current to the at least one array of NREDs.

It will also be appreciated that feedback may not be desired in some implementations. As such, the methods and systems may be suitably modified. Accordingly, as an example, a method for drying or curing a target coating layer deposited on a target substrate comprises moving a coated target substrate item into an irradiation area, the irradiation area being defined by an open-atmosphere enclosure or oven chamber, for irradiation by at least one array of narrowband infrared radiation emitting devices (NREDs) which produce at least 10.4 Watts per square inch of narrowband infrared energy at a target plane, wherein the NREDs are configured to have a Full Width at Half Maximum (FWHM) wavelength spectrum width of less than 80 nanometers (nm) and an output peak wavelength in a range of 720 nm to 1180 nm range, executing a heating process utilizing the at least one array of NREDs to bring the coating layer and the target substrate to a desired state wherein the irradiation area is supplied at least 10.4 Watts of narrowband photonic energy to each of at least 12 square inches of target plane, and wherein the method further comprises continuously controlling amperes of electrical current being supplied by a Direct Current (DC) power supply, using a control system operatively connected to at least one of the DC power supply operatively connected to the at least one array of NREDs or the DC power supply used in conjunction with at least one electrical component which can limit current to the at least one array of NREDs. A corresponding system (such as a modified system of FIG. 3) may also be implemented.

The above description merely provides a disclosure of particular embodiments and is not intended for the purpose of limiting the same hereto. As such, it is not limited to only the above-described applications or embodiments. This disclosure addressed many applications broadly and others specifically. It is recognized that one skilled the art could conceive of alternative applications and specific embodiments that fall within the scope hereof.

We claim:

1. A method for drying or curing a target coating layer deposited on a target substrate comprising:
moving a coated target substrate item into an irradiation area, the irradiation area being defined by an open-atmosphere enclosure or oven chamber including at least one sensor, for irradiation by at least one array of narrowband infrared radiation emitting devices (NREDs) which produce at least 10.4 Watts per square inch of narrowband infrared energy at a target plane, wherein the NREDs are configured to have a Full Width at Half Maximum (FWHM) wavelength spectrum width of less than 80 nanometers (nm) and an output peak wavelength in a range of 720 nm to 1180 nm range, wherein a wavelength peak of selected narrowband energy has an absorption rate in the target substrate which is at least 75% that of the target coating layer and wherein, if the target coating layer is in liquid form, an absorption rate at the selected peak output wavelength of the target substrate is at least one of two times that of water and two times that of a primary liquid in the target coating layer;
detecting, in the irradiation area using the at least one sensor, at least one physical property of at least one of the target coating layer, the target substrate, or a particular molecule in the atmosphere of the enclosure or oven chamber;
collecting information from the at least one sensor on the at least one detected physical property;
translating the information on the at least one detected physical property into a measurement or sequence of measurements; and,
executing a heating process utilizing the at least one array of NREDs and utilizing instructions to bring the coating layer and the target substrate to a desired state in accordance with the measurement, the sequence of measurements, or the collected information from the at least one sensor,
wherein the method further comprises continuously controlling amperes of electrical current being supplied by a Direct Current (DC) power supply, using a control system operatively connected to at least one of the DC power supply operatively connected to the at least one array of NREDs or the DC power supply used in conjunction with at least one electrical component which can limit current to the at least one array of NREDs.

2. The method as set forth in claim 1 wherein the irradiation area is supplied at least 10.4 Watts of narrowband photonic energy to each of at least 12 square inches of target plane.

3. The method set forth in claim 1 wherein the at least one sensor is a sensor operatively connected to the control system.

4. The method as set forth in claim 1 wherein the at least one sensor is placed in at least one of before, in, and after the at least one irradiation zone, if the target substrate is being irradiated by moving it through the irradiation area.

5. The method set forth in claim 1 wherein the instructions comprise stored code.

6. The method set forth in claim 1 wherein the executing of the heating process includes utilizing information from at least one of machine learning algorithms and artificial intelligence.

7. The method set forth in claim 1 wherein the target substrate is moved through the irradiation area, the target substrate is coated within at least one of an area before entering the irradiation area, an area within the irradiation area, and an area of after exiting the irradiation area.

8. The method as set forth in claim 1 wherein the at least one sensor is a temperature sensor.

9. The method as set forth in claim 1 wherein the at least one sensor is an infrared sensor, calibrated to monitor temperature.

10. The method as set forth in claim 1 wherein the at least one sensor is an infrared camera.

11. The method as set forth in claim 1 wherein the at least one sensor is a digital, visible light, camera.

12. The method as set forth in claim 1 wherein the at least one sensor is a Raman spectral sensor.

13. A method for drying or curing a target coating layer deposited on a target substrate in which the target substrate has temperature sensitivity of at least becoming softer and deforming at higher temperatures, the method comprising:
moving a coated target substrate item into an irradiation area, the irradiation area being defined by an open-atmosphere enclosure or oven chamber including at least one sensor, for irradiation by at least one array of narrowband infrared radiation emitting devices (NREDs) which produce at least 10.4 Watts per square inch of narrowband infrared energy at a target plane, wherein the NREDs are configured to have a Full Width at Half Maximum (FWHM) wavelength spectrum width of less than 80 nanometers (nm) and an output peak wavelength in a range of 720 nm to 1180 nm range, wherein a wavelength peak of selected narrowband energy has an absorption rate in the target substrate which is at least 75% that of the target coating layer and wherein, if the target coating layer is in liquid form, an absorption rate at the selected peak output wavelength of the target substrate is at least one of two times that of water and two times that of a primary liquid in the target coating layer;
detecting, in the irradiation area using the at least one sensor, at least one physical property of at least one of the target coating layer, the target substrate, or a particular molecule in the atmosphere of the enclosure or oven chamber;
collecting information from the at least one sensor on the at least one detected physical property;
translating the information on the at least one detected physical property into a measurement or sequence of measurements; and,
executing a heating process utilizing the at least one array of NREDs and instructions to maintain a majority of the target substrate below a glass transition temperature or an autoignition temperature of the target substrate for a duration of the heating process in accordance with the at least one sensor positioned in the system through varying at least one of irradiation intensity, activation time of the NRED's, and speed of conveyance through the irradiation zone,
wherein the method further comprises continuously controlling amperes of electrical current being supplied by a Direct Current (DC) power supply, using a control system operatively connected to at least one of the DC power supply operatively connected to the at least one array of NREDs or the DC power supply used in conjunction with at least one electrical component which can limit current to the at least one array of NREDs.

14. The method as set forth in claim 13 wherein the irradiation area is supplied at least 10.4 Watts of narrowband photonic energy to each of at least 12 square inches of target plane.

15. The method set forth in claim 13 wherein the at least one sensor position is operatively connected to the control system.

16. The method as set forth in claim 13 wherein the at least one sensor is placed in at least one of before, in, and after the irradiation area.

17. The method set forth in claim 13 wherein the instructions comprise stored software code.

18. The method set forth in claim 17 wherein the software code is informed of instructions for the heating process based on historical sensor input data and at least one of machine learning algorithms and artificial intelligence.

19. The method set forth in claim 13 wherein the target substrate is moved through the irradiation area and is coated within at least one of an area before entering the irradiation area, an area within the irradiation area, and an area after exiting the irradiation area.

20. The method as set forth in claim 13 wherein the at least one sensor is a temperature sensor.

21. The method as set forth in claim 13 wherein the at least one sensor is an infrared sensor, calibrated to monitor temperature.

22. The method as set forth in claim 13 wherein the at least one sensor is an infrared camera.

23. The method as set forth in claim 13 wherein the at least one sensor is a digital, visible light, camera.

24. The method as set forth in claim 13 wherein the at least one sensor is a spectral image sensor.

25. The method as set out in claim 13 wherein NREDs having a FWHM wavelength spectrum width of less than 80 nm and an output peak wavelength in the 720 nm to 1180 nm range are further paired with any type of broadband heat source.

26. The method set forth in claim 25, wherein the broadband heat source comprises one of quartz lamps, halogen lamps, heating from chemical reactions such as oxidizing combustibles to create flames, or resistive heating elements.

27. A system for drying or curing a target coating layer deposited on a target substrate comprising:
at least one array of narrowband infrared radiation emitting devices (NREDs) configured to emit energy in a narrow wavelength band suitable for implementing a drying or curing process for the target coating layer on the target substrate;
at least one sensor positioned to detect or measure physical properties of at least one of the target coated layer, the target substrate, or a particular molecule in an atmosphere; and,
at least one processor and at least one memory having stored thereon code or instructions that, when executed by the processor, cause the system to
move a coated target substrate item into an irradiation area, the irradiation area being defined by an open-atmosphere enclosure or oven chamber including at least one sensor, for irradiation by at least one array of narrowband infrared radiation emitting devices (NREDs) which produce at least 10.4 Watts per square inch of narrowband infrared energy at a target plane, wherein the NREDs are configured to have a Full Width at Half Maximum (FWHM) wavelength spectrum width of less than 80 nanometers (nm) and an output peak wavelength in a range of 720 nm to 1180 nm range, wherein a wavelength peak of selected narrowband energy has an absorption rate in the target substrate which is at least 75% that of the target coating layer and wherein, if the target coating layer is in liquid form, an absorption rate at the selected peak output wavelength of the target substrate is at least one of two times that of water and two times that of a primary liquid in the target coated layer;
detect, in the irradiation area using the at least one sensor, at least one physical property of at least one of the target coating layer, the target substrate, or the particular molecule in the atmosphere of the enclosure or oven chamber;
collect information from the at least one sensor on the at least one detected physical property;
translate the information on the at least one detected physical property into a measurement or a sequence of measurements; and,
execute a heating process utilizing the at least one array of NREDs and instructions to bring the coating layer and the target substrate to a desired state in accordance with the measurement, the sequence of measurements, or the collected information from the at least one sensor,
wherein the system is further caused to continuously control amperes of electrical current being supplied by a Direct Current (DC) power supply, using a control system operatively connected to at least one of the DC power supply operatively connected to the at least one array of NREDS or the DC power supply used in conjunction with at least one electrical component which can limit current to the at least one array of NREDs.

28. The system as set forth in claim 27 wherein the irradiation area is supplied at least 10.4 Watts of narrowband photonic energy to each of at least 12 square inches of target plane.

29. The system as set forth in claim 27 wherein the irradiation area is supplied at least 10.4 Watts of narrowband photonic energy to each of at least 40 square inches of target plane.

30. A system for drying or curing a target coating layer deposited on a target substrate in which the target substrate has temperature sensitivity of at least becoming softer and deforming at higher temperatures, the system comprising:
at least one array of narrowband infrared radiation emitting devices (NREDs) configured to emit energy in a narrow wavelength band suitable for implementing a drying or curing process for the target coating layer on the target substrate;
at least one sensor positioned to detect or measure physical properties of at least one of the target coating layer, the target substrate, or a particular molecule in an atmosphere; and,
at least one processor and at least one memory having stored thereon code or instructions that, when executed by the processor, cause the system to
move a coated target substrate item into an irradiation area, the irradiation area being defined by an open-atmosphere enclosure or oven chamber including at least one sensor, for irradiation by at least one array of narrowband infrared radiation emitting devices (NREDs) which produce at least 10.4 Watts per square inch of narrowband infrared energy at a target plane, wherein the NREDs are configured to have a Full Width at Half Maximum (FWHM) wavelength spectrum width of less than 80 nanometers (nm) and an output peak wavelength in a range of 720 nm to 1180 nm range, wherein a wavelength peak of selected narrowband energy has an absorption rate in the target substrate which is at least 75% that of the target coating layer and wherein, if the target coating layer is in liquid form, an absorption rate at the selected peak output wavelength of the target substrate is at least one of two times that of water and two times that of a primary liquid in the target coating layer;
detect, in the irradiation area using the at least one sensor, at least one physical property of at least one of the target coating layer, the target substrate, or a particular molecule in the atmosphere of the enclosure or oven chamber;
collect information from the at least one sensor on the at least one detected physical property;
translate the information on the at least one detected physical property into a measurement or a sequence of measurements; and,
execute a heating process utilizing the at least one array of NREDs and instructions to maintain a majority of the target substrate below a glass transition temperature or an autoignition temperature of the target substrate for a duration of the heating process in accordance with the at least one sensor positioned in the system through varying at least one of irradiation intensity, activation time of the NRED's, and speed of conveyance through the irradiation zone,
wherein the system is further caused to continuously control amperes of electrical current being supplied by a Direct Current (DC) power supply, using a control system operatively connected to at least one of the DC power supply operatively connected to the at least one array of NREDS or the DC power supply used in conjunction with at least one electrical component which can limit current to the at least one array of NREDs.

31. The system as set forth in claim 30 wherein the irradiation area is supplied at least 10.4 Watts of narrowband photonic energy to each of at least 12 square inches of target plane.

32. The system as set forth in claim 30 wherein the irradiation area is supplied at least 10.4 Watts of narrowband photonic energy to each of at least 40 square inches of target plane.

33. A method for drying or curing a target coating layer deposited on a target substrate comprising:
moving a coated target substrate item into an irradiation area, the irradiation area being defined by an open-atmosphere enclosure or oven chamber, for irradiation by at least one array of narrowband infrared radiation emitting devices (NREDs) which produce at least 10.4 Watts per square inch of narrowband infrared energy at a target plane, wherein the NREDs are configured to have a Full Width at Half Maximum (FWHM) wavelength spectrum width of less than 80 nanometers (nm) and an output peak wavelength in a range of 720 nm to 1180 nm range;
executing a heating process utilizing the at least one array of NREDs to bring the coating layer and the target substrate to a desired state wherein the irradiation area is supplied at least 10.4 Watts of narrowband photonic energy to each of at least 12 square inches of target plane,
and wherein the method further comprises continuously controlling amperes of electrical current being supplied by a Direct Current (DC) power supply, using a control system operatively connected to at least one of the DC power supply operatively connected to the at least one array of NREDs or the DC power supply used in conjunction with at least one electrical component which can limit current to the at least one array of NREDs.

34. A system for drying or curing a target coating layer deposited on a target substrate comprising:
at least one array of narrowband infrared radiation emitting devices (NREDs) configured to emit energy in a narrow wavelength band suitable for implementing a drying or curing process for the target coating layer on the target substrate; and,
at least one processor and at least one memory having stored thereon code or instructions that, when executed by the processor, cause the system to
move a coated target substrate item into an irradiation area, the irradiation area being defined by an open-atmosphere enclosure or oven chamber, for irradiation by at least one array of narrowband infrared radiation emitting devices (NREDs) which produce at least 10.4 Watts per square inch of narrowband infrared energy at a target plane, wherein the NREDs are configured to have a Full Width at Half Maximum (FWHM) wavelength spectrum width of less than 80 nanometers (nm) and an output peak wavelength in a range of 720 nm to 1180 nm range; and,
execute a heating process utilizing the at least one array of NREDs and instructions to bring the coating layer and the target substrate to a desired state wherein the irradiation area is supplied at least 10.4 Watts of narrowband photonic energy to each of at least 12 square inches of target plane,
and wherein the system is further caused to continuously control amperes of electrical current being supplied by a Direct Current (DC) power supply, using a control system operatively connected to at least one of the DC power supply operatively connected to the at least one array of NREDS or the DC power supply used in conjunction with at least one electrical component which can limit current to the at least one array of NREDs.
